(19) United States
(12) Patent Application Publication
(10) Pub. No.: US 2009/0183340 A1
(43) Pub. Date: Jul. 23, 2009

(54) Sliding hinge

(75) Inventor: Chen-Wei Chiang, Shulin City (TW)

Correspondence Address: BACON & THOMAS, PLLC, 625 SLATERS LANE, FOURTH FLOOR, ALEXANDRIA, VA, 22314-1176, US

(73) Assignee: SHIN ZU SHING CO. LTD., Shulin City (TW)

(21) Appl. No.: 12/010,130

(22) Filed: Jan. 22, 2008

(51) Int. Cl. E05F 1/16; E05D 7/00

(52) U.S. Cl. 16/327

(57) ABSTRACT

A sliding hinge is mounted in an electronic device and has a stationary bracket, a sliding bracket, a resilient element and a positioning assembly. The stationary bracket is connected to a base of the electronic device. The sliding bracket is connected to a cover of the electronic device, is mounted slidably on the stationary bracket and has a body. The resilient element is mounted the stationary bracket and the body of the sliding bracket to provide effectively friction to maintain the cover at any desired position. The positioning assembly is formed on the stationary bracket, the sliding bracket and the resilient element to simplify the assembling procedure.

### BACKGROUND OF THE INVENTION

1. Field of the Invention

The present invention relates to a sliding hinge, especially to a sliding hinge with positioning elements.

2. Description of the Prior Arts

Sliding-design electronic devices including cell phones, PDAs or the like comprise a cover with a display, a base with a keyboard and main electronic elements, and a conventional sliding hinge. The conventional sliding hinge is mounted between the cover and the base to allow the cover sliding relative to the base.

With reference to FIG. 14, a conventional sliding hinge comprises a stationary bracket (40), a sliding bracket (50), a resilient element (60) and a positioning element (70). The stationary bracket (40) has two sliding channels (41) and two positioning holes (42). The sliding channels (41) are formed respectively in sidewalls. The positioning holes (42) are formed separately through a bottom of the stationary bracket (40). The sliding bracket (50) is mounted slidably on the stationary bracket (40) and has two extensions (51) formed respectively on the sides. The extensions (51) are mounted slidably in the sliding channels (41). The resilient element (60) has two main sheets (61) and two connecting sheets (62). The main sheets (61) are mounted between the extensions (51) and the bottom of the stationary bracket (40) to provide friction to maintain the cover at any desired position. The connecting sheets (62) are respectively connected between the main sheets (61). The positioning element (70) is mounted between the sliding bracket (50) and the stationary bracket (40), is mounted between main sheets (61) of the resilient element (60) and has a positioning protrusion (71) selectively engaging the positioning holes (42) of the stationary bracket (40) to provide positioning function.

However, the conventional sliding hinge has following disadvantages:

1. The resilient element (60) and the positioning element (70) are two independent elements. The resilient and positioning elements (60, 70) have no connecting segments but have to maintain at corresponding position. The assembling of the resilient and positioning elements (60, 70) only relies on the pressing of the stationary and sliding brackets (40, 50). Therefore, the assembling of the conventional sliding hinge is complicated and hard.

2. The resilient element (60) is used to provide friction but only contacts with the extensions (51) of the sliding bracket (50). The small contacting surface causes the sliding bracket (50) slides unstably relative to the stationary bracket (40) and also limits the providing friction.

To overcome the shortcomings, the present invention provides a sliding hinge to mitigate or obviate the aforementioned problems.

### SUMMARY OF THE INVENTION

The main objective of the present invention is to provide a sliding hinge that simplifies assembling procedure and effectively provides friction. The sliding hinge is mounted in an electronic device and has a stationary bracket, a sliding bracket, a resilient element and a positioning assembly. The stationary bracket connects to a base of the electronic device. The sliding bracket connects to a cover of the electronic device, is mounted slidably on the stationary bracket and has a body. The resilient element is mounted the stationary bracket and the body of the sliding bracket to provide effectively friction to maintain the cover at any desired position. The positioning assembly is formed on the stationary bracket, the sliding bracket and the resilient element to simplify the assembling procedure.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a sliding hinge in accordance with the present invention;

FIG. 2 is an exploded perspective view of the sliding hinge in FIG. 1;

FIG. 3 is an end view in partial section of the sliding hinge in FIG. 1;

FIG. 4 is an operational side view in partial section of the sliding hinge in FIG. 1;

FIG. 5 is another operational side view in partial section of the sliding hinge in FIG. 1;

FIG. 6 is a perspective view of a second embodiment of a sliding hinge in accordance with the present invention;

FIG. 7 is an exploded perspective view of the sliding hinge in FIG. 6;

FIG. 8 is an operational side view in partial section of the sliding hinge in FIG. 6;

FIG. 9 is another operational side view in partial section of the sliding hinge in FIG. 6;

FIG. 10 is a perspective view of a third embodiment of a sliding hinge in accordance with the present invention;

FIG. 11 is an exploded perspective view of the sliding hinge in FIG. 10;

FIG. 12 is an operational side view in partial section of the sliding hinge in FIG. 10;

FIG. 13 is another operational side view in partial section of the sliding hinge in FIG. 10; and

FIG. 14 is an exploded perspective view of a conventional sliding hinge in accordance with the prior art.

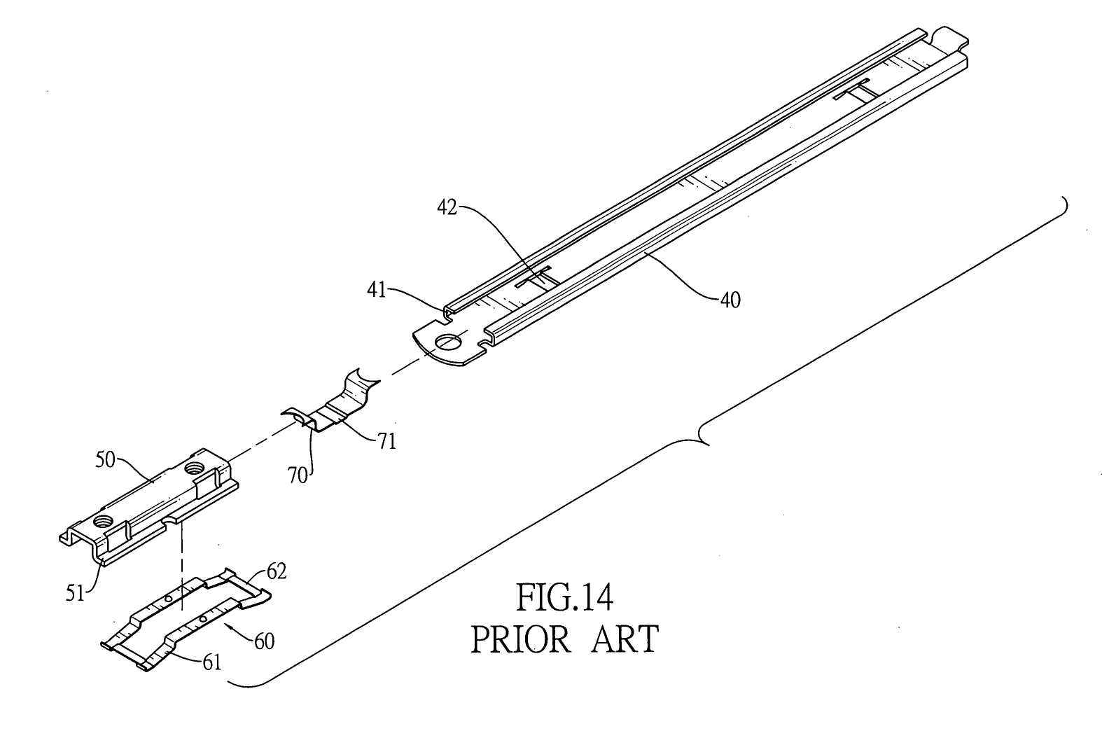

### DETAILED DESCRIPTION OF THE PREFERRED EMBODIMENTS

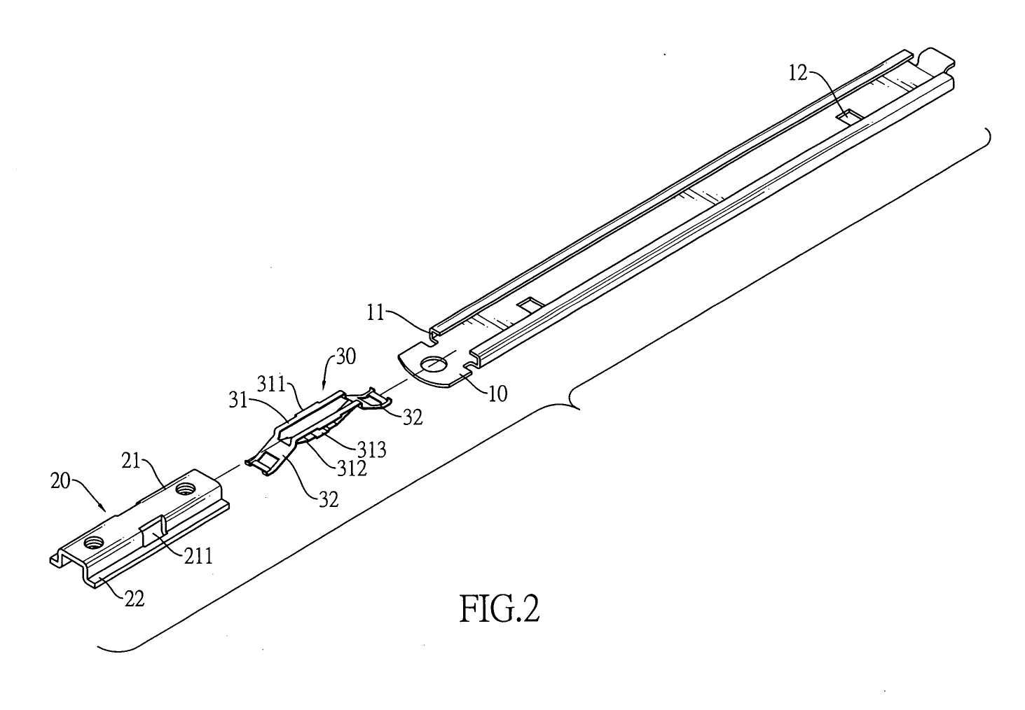

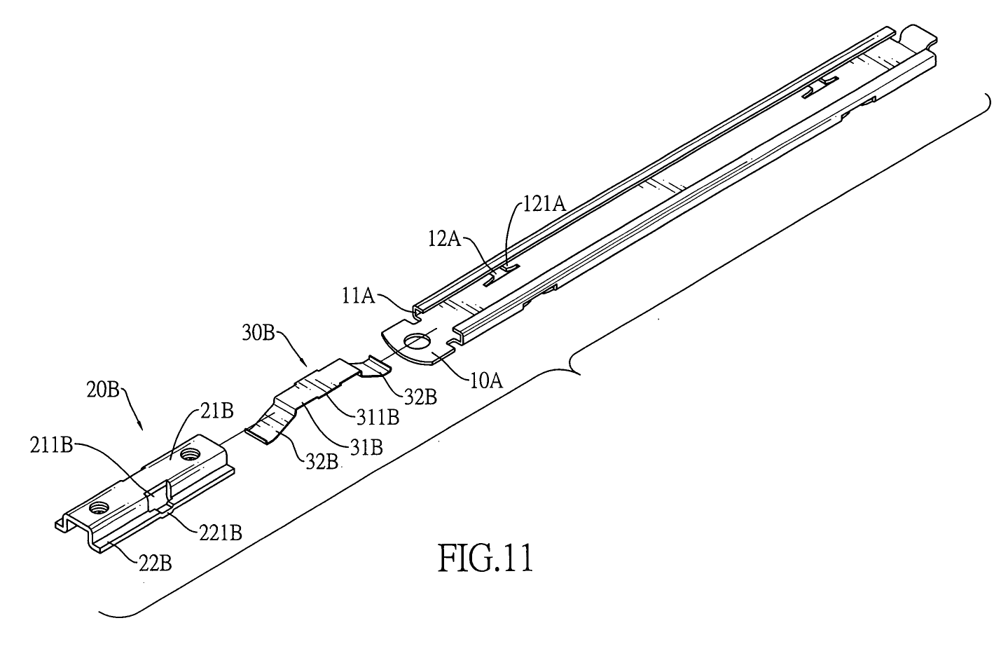

With reference to FIGS. 2, 7 and 11, a sliding hinge in accordance with the present invention comprises a stationary bracket (10, 10A), a sliding bracket (20, 20A, 20B), a resilient element (30, 30A, 30B) and a positioning assembly.

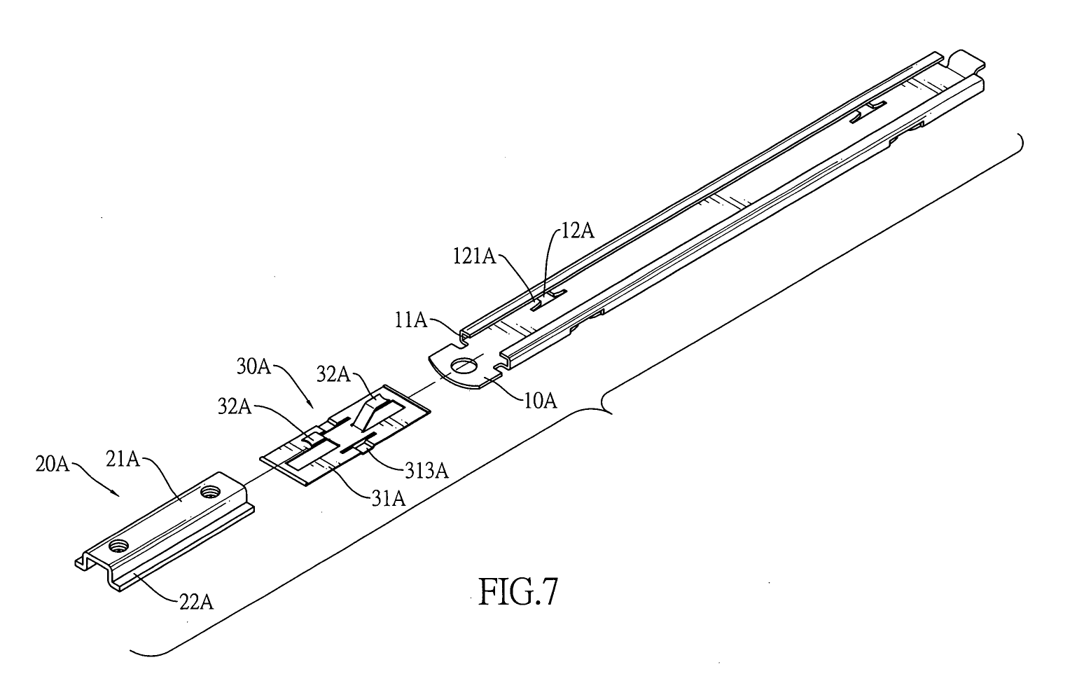

With reference to FIGS. 2 and 7, the stationary bracket (10, 10A) is a longitudinal bracket, and has two inside walls, a bottom, two ends, two sliding channels (11, 11A) and multiple positioning holes (12, 12A). The sliding channels (11, 11A) are formed respectively in the inside walls and are opposite to each other. The positioning holes (12, 12A) are formed separately through the bottom respectively near the ends and may be formed respectively through the sidewalls. Each positioning hole (12A) has two ends and two inclined protrusions (121A). The inclined protrusions (121A) are formed respectively on the two ends of the positioning hole (12A).

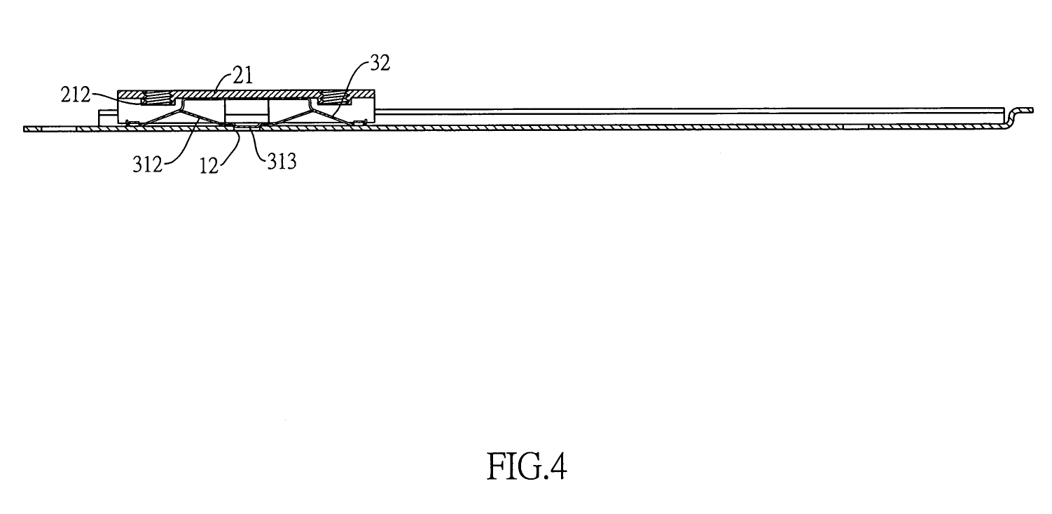

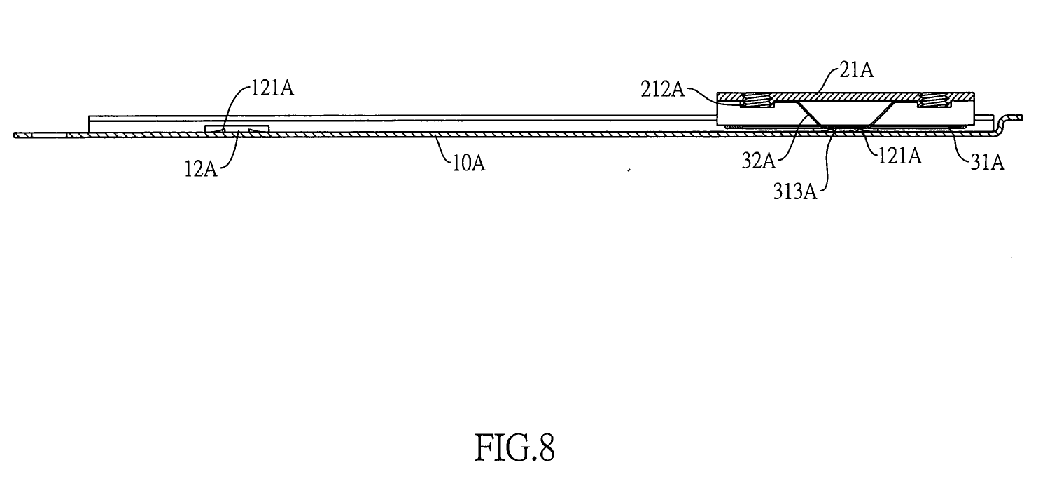

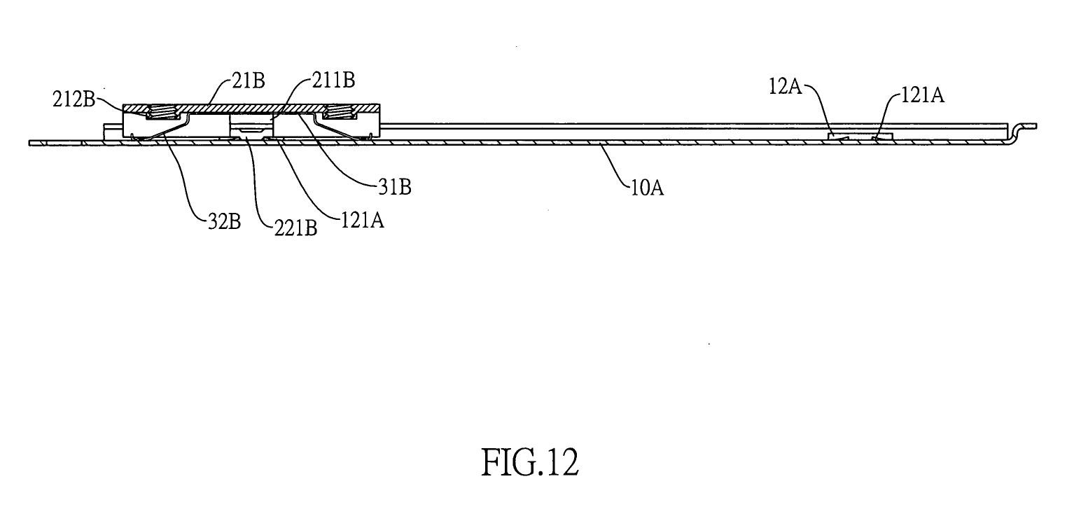

With reference to FIGS. 2, 4, 7, 8, 11 and 12, the sliding bracket (20) is mounted slidably on the stationary bracket (10) and has a U-shaped body (21, 21A, 21B) and two extensions (22, 22A, 22B).

The body (21, 21A, 21B) has two sidewalls, a bottom surface, two through holes (211, 211B) and two clamping protrusions (212, 212A, 212B). Each sidewall of the body (21, 21A, 21B) has a distal end. The through holes (211, 211B) are formed respectively through the sidewalls of the body (21, 21B). The clamping protrusions (212, 212A, 212B) are formed on the bottom surface of the body (21, 21A, 21B). Each clamping protrusion (212, 212A, 212B) is hollow and has internal threads.

The extensions (22, 22A, 22B) are formed on and transversely protrude out from the distal ends of the sidewalls of the body (21, 21A, 21B), are perpendicular with the sidewalls of the body (21, 21A, 21B) and are respectively mounted slidably in the sliding channels (11, 11A). Each extension (22B) has a bottom surface and a positioning protrusion (221B). The positioning protrusion (221B) is formed on and protrudes out from the bottom surface of the extension (22B) and selectively engages between the inclined protrusions (121A) of the stationary bracket (10) to provide positioning function.

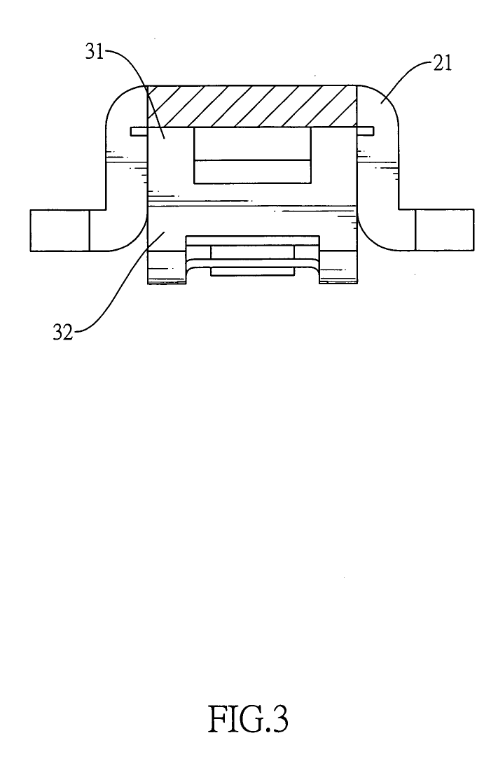

With reference to FIGS. 2, 3, 7 and 11, the resilient element (30, 30A, 30B) is mounted between the stationary bracket (10, 10A) and the body (21, 21A, 21B) of the sliding bracket (20, 20A, 20B) to provide friction, connects securely to the sliding bracket (20, 20A, 20B) and has a main sheet (31, 31A, 31B) and two legs (32, 32A, 32B).

The main sheet (31, 31A, 31B) has a central part, two sides, two ends, a bottom surface, a top surface, two fastening protrusions (311, 311B), an additional sheet (312) and a positioning protrusion (313) or two positioning protrusions (313A). The main sheet (31, 31B) may abut the body (21, 21B) of the sliding bracket (20, 20B), or the main sheet (31A) may abut the stationary bracket (10A). The fastening protrusions (311, 311B) are formed respectively on and protrude out from the sides of the main sheet (31, 31B) and respectively engage the through holes (211, 211B) of the sliding bracket (20, 20B) to connect the resilient element (20, 20B) securely to the sliding bracket (20, 20B). The additional sheet (312) is formed downward in the central part of the main sheet (31) to form an opening, abuts the stationary bracket (10) and has a bottom surface. The positioning protrusion (313) may be formed on the bottom surface of the additional sheet (312) and selectively engage the positioning holes (12) of the stationary bracket (10), or the positioning protrusions (313A) may be formed on the bottom surface of the main sheet (31A) and selectively engage between the corresponding inclined protrusions (121A) of the stationary bracket (10) to provide positioning function.

The legs (32, 32A, 32B) protrude oppositely out from the main sheet (31, 31A, 31B). The legs (32, 32B) may be formed respectively on and protrude out from the ends of the main sheet (31, 31B) and may abut the stationary bracket (10, 10A). Or the legs (32A) may be formed oppositely on and protrude out from the top surface of the main sheet (31A), may abut the body (21A) of the sliding bracket (20A) and may be clamped between the clamping protrusions (212A) of the sliding bracket (20A) to securely connect the resilient element (30A) to the sliding bracket (20A).

When the sliding hinge as described is used, the stationary bracket (10, 10A) is connected to a base of an electronic device, and the sliding bracket (20, 20A, 20B) is connected to a cover of the electronic device. Therefore, when the cover is slid relative to the base, the sliding bracket (20, 20A, 20B) and the resilient element (30, 30A, 30B) is slid relative to the stationary bracket (10, 10A, 10B).

The positioning assembly is formed on the stationary bracket (10, 10A), the sliding bracket (20, 20A, 20B) and the resilient element (30, 30A, 30B) to selectively maintain the sliding bracket (20, 20A, 20B) at a predetermined position. Therefore, when the cover is slid relative to the base, the positioning assembly allows the cover to maintain at a predetermined position.

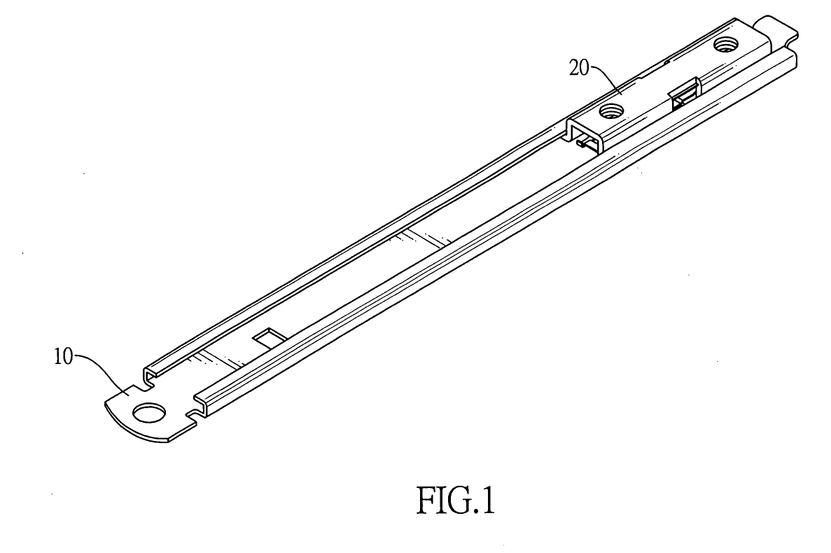

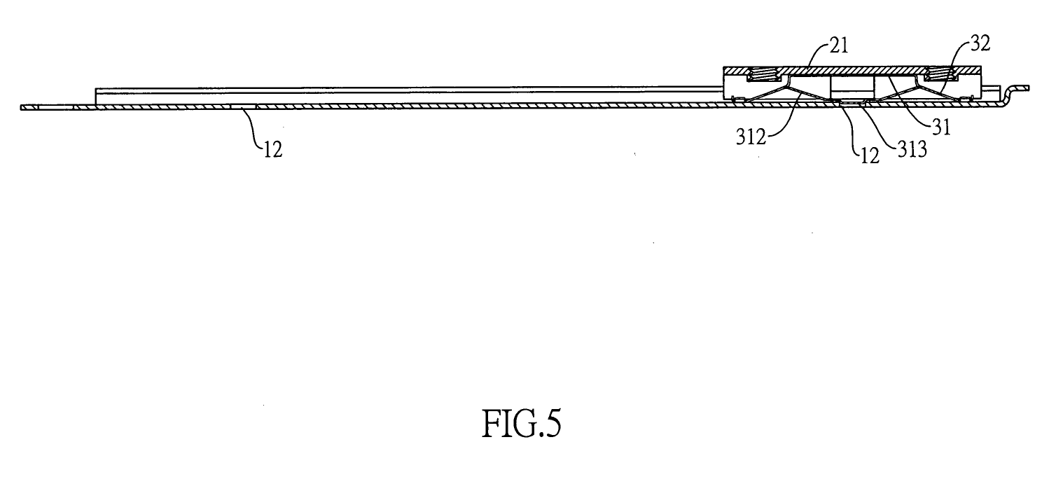

With reference to FIGS. 1 to 5, the positioning assembly of the first embodiment of the sliding hinge of the present invention comprises the positioning hole (12) of the stationary bracket (10), and the additional sheet (312) and the positioning protrusion (313) of the resilient element (30). When the cover is slid, the positioning protrusion (313) selectively engages the positioning holes (12) to maintain the cover at the predetermined positions.

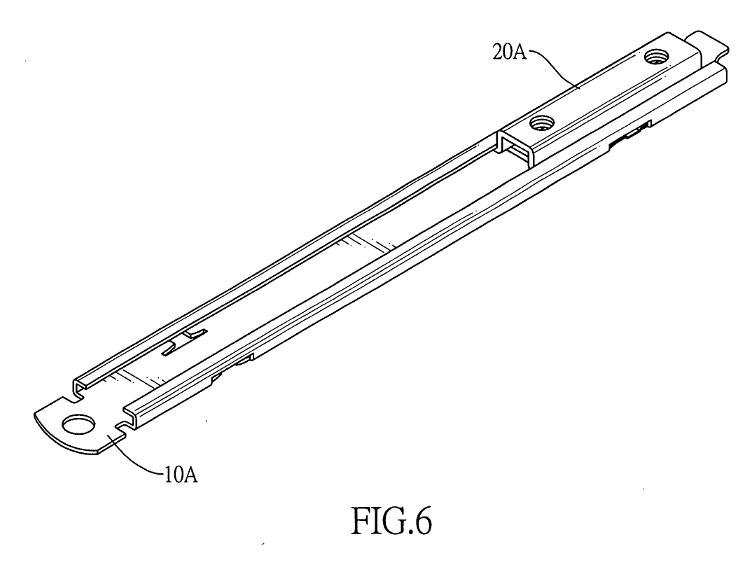

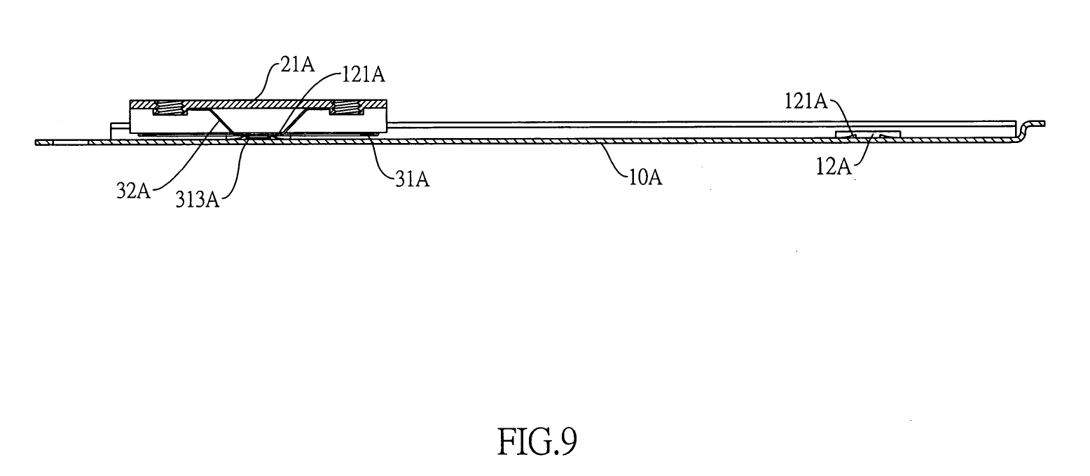

With reference to FIGS. 6 to 9, the positioning assembly of the second embodiment of the sliding hinge of the present invention comprises the positioning holes (12A) and the inclined protrusions (121A) of the stationary bracket (10A), and the positioning protrusions (313A) of the resilient element (30A). When the cover is slid, the positioning protrusions (313A) selectively engage between the inclined protrusions (121A) of the stationary bracket (10) to maintain the cover at the predetermined positions.

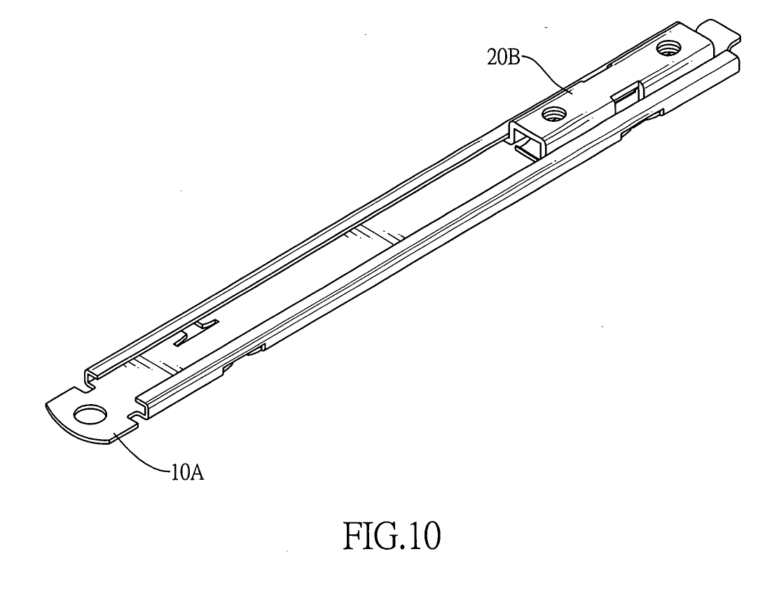

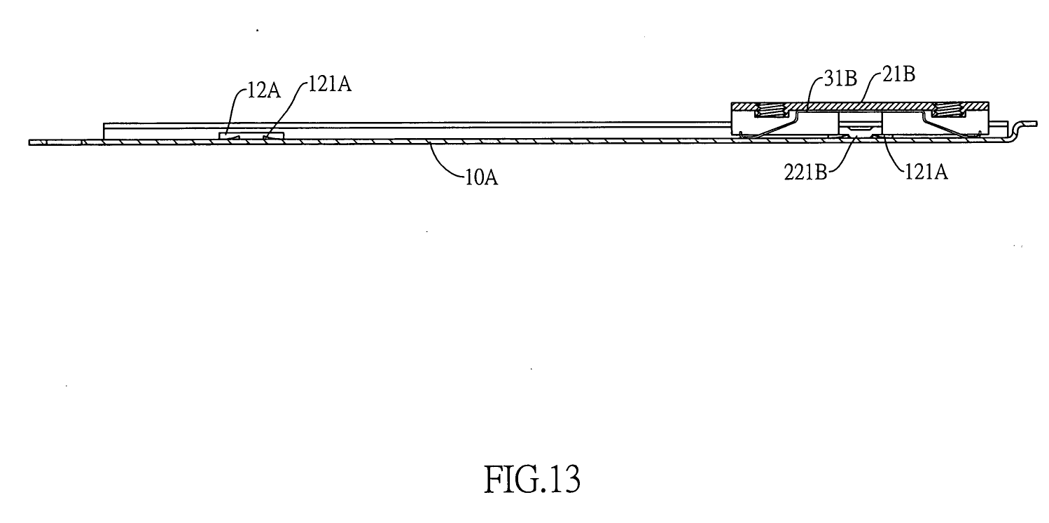

With reference to FIGS. 10 to 13, the positioning assembly of the third embodiment of the sliding hinge of the present invention comprises the positioning holes (12A) and the inclined protrusions (121A) of the stationary bracket (10A), and the positioning protrusions (221B) of the sliding bracket (20B). When the cover is slid, the positioning protrusions (221B) selectively engage between the inclined protrusions (121A) of the stationary bracket (10) to maintain the cover at the predetermined positions.

Therefore, the sliding hinge as described has following advantages:

1. Because the positioning assembly is formed on the stationary bracket (10, 10A), the sliding bracket (20, 20A, 20B) and the resilient element (30, 30A, 30B), the components of the sliding hinge as described is decreased to simplify the assembling procedure.

2. Because the resilient element (30, 30A, 30B) directly contacts with the body (21, 21A, 21B) of the sliding bracket (20, 20A, 20B), the contacting surface is increased to increase the friction. Therefore, the cover is more easily to maintain at any desired position by the friction provided by the resilient element (30, 30A, 30B).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sliding hinge comprising:
a stationary bracket having
two inside walls;
a bottom;
two ends; and
two sliding channels being formed respectively in the inside walls and being opposite to each other;
a sliding bracket being mounted slidably on the stationary bracket and having
a U-shaped body having
two sidewalls, and each sidewall having a distal end; and
a bottom surface; and
two extensions being formed on and transversely protruding out from the distal ends of the sidewalls of the body, being perpendicular with the sidewalls of the body and being respectively mounted slidably in the sliding channels of the stationary bracket, and each extension has a bottom surface;
a resilient element being mounted between the stationary bracket and the body of the sliding bracket, connecting securely to the sliding bracket and having
a main sheet having a central part, two sides, two ends, a bottom surface and a top surface; and
two legs protruding oppositely from the main sheet; and
a positioning assembly being formed on the stationary bracket, the sliding bracket and the resilient element to selectively maintain the sliding bracket at a position.

2. The sliding hinge as claimed in claim 1, wherein
the main sheet of the resilient element abuts the body of the sliding bracket; and
the legs of the resilient element are formed respectively on and protrude out from the ends of the main sheet and abut the stationary bracket.

3. The sliding hinge as claimed in claim 2, wherein
the body of the sliding bracket has two through holes being formed respectively through the sidewalls of the body; and
the main sheet of the resilient element has two fastening protrusions being formed respectively on and protruding out from the sides of the main sheet and respectively engage the through holes of the sliding bracket.

4. The sliding hinge as claimed in claim 1, wherein
the main sheet of the resilient element abuts the stationary bracket; and
the legs of the resilient element are formed oppositely on and protrude out from the top surface of the main sheet and abut the body of the sliding bracket.

5. The sliding hinge as claimed in claim 4, wherein
the body of the sliding bracket has two clamping protrusions being formed on the bottom surface of the body; and
the legs of the resilient element are clamped between the clamping protrusions of the sliding bracket.

6. The sliding hinge as claimed in claim 5, wherein each clamping protrusion of the sliding bracket is hollow and has internal threads.

7. The sliding hinge as claimed in claim 1, wherein the positioning assembly has
two positioning holes being formed separately through the bottom of the stationary bracket respectively near the ends of the stationary bracket;
an additional sheet being formed downward in the central part of the main sheet to form an opening, abutting the stationary bracket and having a bottom surface; and
a positioning protrusion being formed on the bottom surface of the additional sheet and selectively engaging the positioning holes.

8. The sliding hinge as claimed in claim 2, wherein the positioning assembly has
two positioning holes being formed separately through the bottom of the stationary bracket respectively near the ends of the stationary bracket;
an additional sheet being formed downward in the central part of the main sheet to form an opening, abutting the stationary bracket and having a bottom surface; and
a positioning protrusion being formed on the bottom surface of the additional sheet and selectively engaging the positioning holes.

9. The sliding hinge as claimed in claim 3, wherein the positioning assembly has
two positioning holes being formed separately through the bottom of the stationary bracket respectively near the ends of the stationary bracket;
an additional sheet being formed downward in the central part of the main sheet to form an opening, abutting the stationary bracket and having a bottom surface; and
a positioning protrusion being formed on the bottom surface of the additional sheet and selectively engaging the positioning holes.

10. The sliding hinge as claimed in claim 1, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being formed on the bottom surface of the main sheet and selectively engaging between corresponding inclined protrusions.

11. The sliding hinge as claimed in claim 4, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being formed on the bottom surface of the main sheet and selectively engaging between corresponding inclined protrusions.

12. The sliding hinge as claimed in claim 5, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being formed on the bottom surface of the main sheet and selectively engaging between corresponding inclined protrusions.

13. The sliding hinge as claimed in claim 6, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being formed on the bottom surface of the main sheet and selectively engaging between corresponding inclined protrusions.

14. The sliding hinge as claimed in claim 1, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being respectively formed on and protruding out from the bottom surfaces of the extensions of the sliding bracket and selectively engaging between corresponding inclined protrusions.

15. The sliding hinge as claimed in claim 2, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being respectively formed on and protruding out from the bottom surfaces of the extensions of the sliding bracket and selectively engaging between corresponding inclined protrusions.

16. The sliding hinge as claimed in claim 3, wherein the positioning assembly has
four positioning holes being formed separately through the bottom of the stationary bracket respectively near the ends of the stationary bracket and being formed respectively through the sidewalls of the stationary bracket, and each positioning hole having two ends and two inclined protrusions being formed respectively on the two ends of the positioning hole; and
two positioning protrusions being respectively formed on and protruding out from the bottom surfaces of the extensions of the sliding bracket and selectively engaging between corresponding inclined protrusions.
